(19) United States
(12) Patent Application Publication
(10) Pub. No.: US 2020/0210855 A1
(43) Pub. Date: Jul. 2, 2020

(54) DOMAIN KNOWLEDGE INJECTION INTO SEMI-CROWDSOURCED UNSTRUCTURED DATA SUMMARIZATION FOR DIAGNOSIS AND REPAIR

(71) Applicant: Robert Bosch GmbH, Stuttgart (DE)

(72) Inventors: Ji Eun KIM, Pittsburgh, PA (US); Wan-Yi LIN, Pittsburgh, PA (US); Lixiu YU, Pittsburgh, PA (US)

(21) Appl. No.: 16/234,783

(22) Filed: Dec. 28, 2018

(51) Int. Cl. G06N 5/02; G06N 20/00; G06F 16/34

(52) U.S. Cl. CPC G06N 5/02; G06F 16/345; G06N 20/00

(57) ABSTRACT

An information synthesis system for generating a knowledge base injects domain knowledge into semi-crowdsourced summarization pipelines for extracting information from unstructured data sources. The summarization pipeline includes chains of tasks completed by crowd workers and/or machined. The information synthesis system distributes the tasks to crowd workers and/or machines. Task responses are processed and aggregated to determine new information that is used to update the knowledge base.

### TECHNICAL FIELD

This application generally relates to a system for injecting domain knowledge and generating tasks for crowd and machine sourced data summarization.

### BACKGROUND

Products can be made up of many components, some of which may be repairable and/or replaceable. In addition, products are more and more complicated to operate. In course of operation, products may not work as intended for various reasons. For example, a component may be worn or broken leading to improper or no operation of the product. Some products may include self-diagnosing features. The self-diagnostic features may cause the product to store and/or display an error code that may be indicative of the problem. In other cases, the product may exhibit problems or symptoms without storing an error code.

A typical procedure may include reading the error code and affecting repairs based on the error code. In some cases, the error code may be indicative of several problems. Further diagnosis and troubleshooting may be required to determine the source of the problem. In other cases, the problem/symptoms may not have an associated error code. In some cases, a problem may not be comprehended by the manufacturer diagnosis and repair procedures. Product diagnosis and repair documentation has typically been produced by domain experts. For example, the manufacturer may task an expert with generating a product repair manual. The repair manual may include diagnosis and repair procedures.

### SUMMARY

An information synthesis system for generating a knowledge base comprising a computing system programmed to distribute templates including tasks for extracting information from unstructured sources to task executors, receive task results from task executors as responses in the templates, identify domain-knowledge representations that are present in the task results but are absent from the knowledge base, generate templates defining the tasks and including the domain-knowledge representations for extracting additional information from unstructured sources.

The tasks may be defined as human-only tasks, machine tasks, and machine-guided tasks. The computing system may be further programmed to distribute the templates based on an availability of the task executors and an accuracy of the task executors. The tasks may include summarizing information from unstructured data sources. The tasks may include summarizing information contained in at least a portion of a video. The computing system may be further programmed to validate task results received from each of the task executors and identify the task results as invalid responsive to a task completion time being less than a predetermined percentage of a duration of the portion of the video. The computing system may be further programmed to validate the task results from each of the task executors and identify the task results as invalid (i) responsive to the task results being the same for a predetermined number of responses, (ii) responsive to the task results including terms identifying components that are absent from an original source that corresponds to the task results, and (iii) responsive to the task results being unique compared to those submitted by other task executors. The computing system may be further programmed to maintain a chain of data for the tasks that includes, for each of the tasks, data defining an original source, a relevant part of the original source, a summarization of the relevant part, and a final summary derived from the summarization for each of tasks. The computing system may be further programmed to facilitate training of one or more machine learning models by providing the chain of data to the machine learning models as training inputs. The computing system may be further programmed to predict accuracy of the task executors prior to distributing the templates.

A method for updating a knowledge base by a computing system includes maintaining a penalty score for a task executor and distributing a task to the task executor responsive to the penalty score being less than a predetermined threshold. The method further includes increasing the penalty score for the task executor to a value greater than the predetermined threshold responsive to the task executor providing more than a predetermined number of responses to tasks that contain domain-specific representations that are not present in an original source associated with the tasks.

The method may further include, increasing the penalty score for the task executor to a value greater than the predetermined threshold responsive to receiving more than a predetermined number of responses from the task executor that are the same for different tasks. The method may further include, increasing the penalty score for the task executor to a value greater than the predetermined threshold responsive to the task executor providing more than a predetermined number of responses that are unique compared to responses submitted by other task executors to a same task. The method may further include, increasing the penalty score for the task executor responsive to the task executor finishing a video-summarization task in a time that is less than a predetermined percentage of a runtime of an assigned video segment. The method may further include invalidating responses that contributed to the penalty score exceeding the predetermined threshold.

A method for synthesizing information from unstructured data sources to update a repair knowledge base comprising identifying relevant parts of original sources having domain-specific knowledge related to the repair knowledge base and creating templates including tasks for summarizing each of the relevant parts. The method further includes distributing the templates to task executors based on availability and accuracy of task executors and aggregating solutions from the templates completed by the task executors to create a repair solution that is described as an action verb followed by a component name. The method further includes updating the repair knowledge base with domain-specific representations from the repair solution that are not presently in the repair knowledge base and creating and distributing new templates based on the domain-specific representations.

The method may further include creating new machine learning model using the original sources, the relevant parts, summaries, and repair solution as training data for updating machine learning models. The repair solution may be described as an action verb followed by a component name. The originals sources may be documents accessed on a web-site. The original sources may be videos accessed on a web-site.

### BRIEF DESCRIPTION OF THE DRAWINGS

FIG. 1 depicts a possible configuration for an information synthesis system for developing a knowledge base.

FIG. 2 depicts a possible block diagram for processes for the information synthesis system.

FIGS. 3A and 3B depict a possible display output for a first example template.

FIGS. 4A and 4B depict a possible display output for a second example template.

FIGS. 5A and 5B depict a possible display output for a third example template.

FIG. 6 depicts a possible display output for a fourth example template.

FIG. 7 depicts a possible display output for a fifth example template.

FIG. 8 depicts a possible display output for a sixth example template.

FIG. 9 depicts a possible display output for a seventh example template.

FIG. 10 depicts a possible display output for an eighth example template.

FIG. 11 depicts a possible sequence of operations for a summarization workflow.

FIG. 12 depicts a block diagram for types of tasks that may be managed by a task configurator.

FIG. 13 depicts a block diagram for a maintaining trace data for updating the knowledge base.

FIG. 14 depicts a possible sequence of operations for implementing the information synthesis system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Prior methods of generating diagnosis and repair instructions have generally leveraged experts in the particular domain. For example, an automotive repair knowledge base may rely on the expertise of trained mechanics or other persons of similar domain knowledge. Having domain expertise is advantageous in that the expert is aware of standard terms and procedures that are typical of the domain. A disadvantage of such methods is that each domain requires a different expert and does not necessarily leverage the efforts of non-experts. Using non-experts in these types of activities may reduce costs. Some benefits may be achieved by applying a crowdsourcing model to the generation of diagnosis and repair knowledge bases.

Crowdsourcing systems may be used to accomplish high-cognitive tasks (e.g., sense-making of photos or written texts) by decomposing the high-cognitive tasks into relatively low-cognitive tasks that can be easily completed by average human workers without professional skills (e.g., without extensive domain knowledge). The crowd workers may be registered in crowdsourcing markets such as Amazon Mechanical Turk. Various design patterns (e.g., find-extract-verify pattern) and quality control mechanisms (e.g., majority voting, gold standard injection) are available to maintain consistent quality of the entire system by minimizing the variation of task result quality from crowd workers.

Systems and methods are disclosed herein for injecting domain knowledge into semi-crowdsourced summarization pipelines for diagnosis and repair knowledge from unstructured data sources such as forums on the web and/or multimedia information such as videos. The summarization pipeline may utilize chains of tasks executed by crowd workers via user interfaces and machine processes via software operation. The system may automatically distribute tasks to task executors and aggregate processed results from task executors. The task executors may be crowd workers and/or machines. The tasks may include summarizing symptoms and errors described by humans or detected by diagnosis tools in a template, searching relevant information sources, extracting the most relevant part from the selected sources and summarizing the extracted information in a template, and grouping similar information as the same or similar solution.

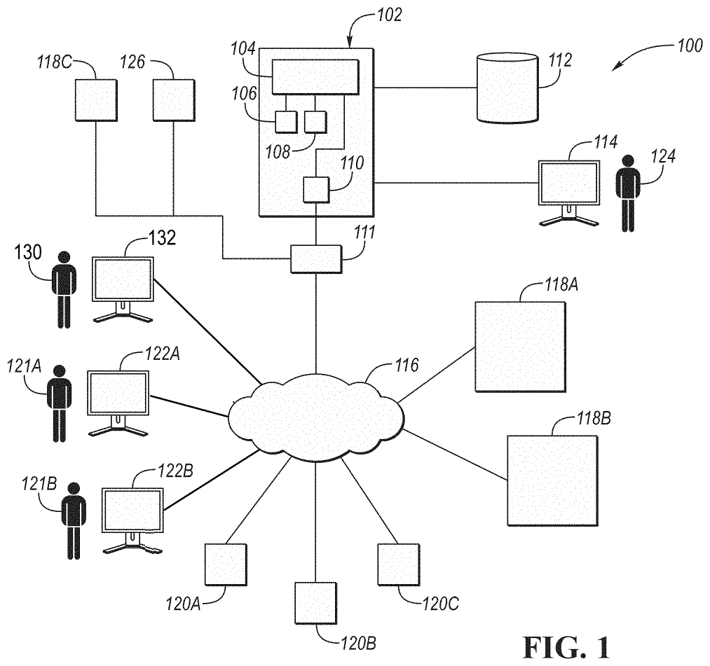

FIG. 1 depicts an information synthesis system (ISS) 100 that may be configured to produce a knowledge base for a given domain. The ISS 100 may be configured to produce a knowledge base for diagnosis and repair of a product or system. The ISS 100 may include at least one computing system 102. The computing system 102 may also be referred to as a knowledge-base server. The computing system 102 may include at least one microprocessor unit 104 that is configured to execute instructions. The computing system 102 may include volatile memory 106 and non-volatile memory 108 for storing instructions and data. The computing system 102 may include a network interface 110 that is configured to provide communication with a network router 111. For example, the network router 111 may be a wired or wireless Ethernet router. In some configurations, the network router 111 establish a local network to connect with one or more local servers 126. The network router 111 may be further configured to provide a communication interface to an external network 116. In some configurations, the computing system 102 may exist as a remote server in a cloud computing architecture (e.g., Amazon Web Services (AWS)).

The external network 116 may be referred to as the world-wide web or the Internet. The external network 116 may establish a standard communication protocol between computing devices. The external network 116 may allow information and data to be easily exchanged between computing devices and networks. At least one server 120 may be in communication with the external network 116. Each server 120 may host a website or webpage from which information may be derived. For example, the server 120 may host a webpage that has information relevant to the domain of interest. There may be many such servers 120 with the information. The servers 120 may host one or more unstructured data sources that provide data in varying formats including a blog, a forum, an article, images, audio, and/or videos. The data may be considered unstructured as there may be no common format between the sources. For example, each web-site may be arranged differently. Domain-relevant information may be repeated on different webpages/websites.

One or more task processing machines 118 may be in communication with the external network 116 (e.g., 118A, 118B). The task processing machines 118 (e.g., 118C) may also be in communication with the local network established by the network router 111. The task processing machines 118 may be configured to execute tasks or programs that are received. The task processing machines 118 may be computing systems that are programmed to receive programs/instructions and data, process the data according to the programs/instructions, and output processed data. The computing system 102 may also perform the functions of the task processing machines 102. That is, the computing system 102 may be configured execute tasks and programs that are generated by the system.

Crowd workers 121 may utilize workstations 122 to access the external network 116. Crowd workers 121 may not be expected to have any domain expertise. The crowd workers 121 may be registered in one or more crowdsourcing markets such as Amazon Mechanical Turk. The crowdsourcing market may be implemented on one of the servers 120. The crowdsourcing market may allow a task requestor to upload tasks for completion by the crowd workers 121. The crowd workers 121 may access the crowdsourcing market using the workstations 122. The workstations 122 may be personal computing devices including a user interface for input and output. For example, the workstations 122 may be computers having a display and keyboard. The workstations 122 may include tablets and cell phones.

The computing system 102 may be directed and managed by one or more administrative users or system administrators 124 through a terminal/workstation/user interface 114 that is in communication with or coupled to the computing system 102. The user interface 114 may be configured to allow the system administrators 124 to access and change information and programs in the computing system 102. The computing system 102 may be in communication with a knowledge base 112. The knowledge base 112 may represent the domain-specific knowledge that is collected and organized by the ISS 100. The knowledge base 112 may be configured to store domain knowledge and representations. The computing system 102 may be programmed with an inference engine that applies rules and logic to find information stored in the knowledge base 112. For example, the knowledge base 112 may be information related to diagnosis and repair of a particular product. The knowledge base 112 may reside on a physical storage device and/or may reside on memory within the computing system 102. The computing system 102 may be programmed to access and present the information contained in the knowledge base 112 to users and administrators. For example, the information contained in the knowledge base 112 may be accessed via a web interface such that external users may access the information via the external network 116. Access may be general (e.g., available to all) or may be restricted (e.g., limited to certain individuals such as registered product repair specialists).

One or more domain experts 130 may utilize workstations 132 to access the external network 116. The domain experts 130 may be persons having specific domain knowledge. The domain experts 130 may provide domain expertise to ensure that the knowledge base 112 includes the proper level of domain knowledge.

The computing system 102 may be configured to build or generate the knowledge base 112 using information found on the servers 120. In some configurations, the computing system 102 may be programmed to implement a search via the external network 116 for domain relevant information. The search may be directed by search terms input by the system administrators 124 or retrieved from the knowledge base 112. The system administrators 124 may inject domain knowledge, such as terms of art in the relevant domain, to direct the search. The search may result in one or more websites or Uniform Resource Locator (URL)/web addresses that contain information relevant to the search terms. Once potential sources of domain-relevant data are identified, the sources may be examined to determine if relevant information is present that can improve the knowledge base 112.

The computing system 102 may be programmed to facilitate generating tasks that may be assigned to task executors (e.g., crowd workers 121 and task processing machines 118) for completion. The tasks may define a workflow or pipeline for processing and synthesizing information. The tasks may be configured to generate summaries of information sources that are relevant to the domain for which knowledge is being gathered. The summarization pipeline may be adapted to predict the accuracy of task executors (e.g., crowd workers 121 and/or machines 118) and may be configured to change over time to improve the quality of the solutions. The tasks may be structured so that crowd workers 121 do not need extensive domain-specific knowledge to complete the task.

New data discovered/learned throughout the pipeline may be used to update the knowledge base 112 and used to support and design additional tasks. An example of information stored in the knowledge base 112 may be a dictionary consisting of appliance or vehicle components including representative words, synonyms, acronyms, multimedia contents, along with different attributes/relationships between the terms such as product information, symptom descriptions, and repair solutions. The knowledge base 112 may store information regarding error codes, symptom descriptions, and related information (e.g., diagnosis and repair instructions).

The computing system 102 may implement various computational approaches for information synthesis. Question Answering (QA) research addresses the methods and systems for automatically answering questions posted by humans in natural language. The complex, interactive QA (ciQA) may be utilized in addition to factoid and list QA. Semi-automated QA approaches (and their crowd-based variants) may focus on answering short, factual questions instead of completing complex sense-making processes.

Multi-document summarization aims to use computational techniques to extract information from multiple texts written for the same topic using feature-based, cluster-based, graph-based, and knowledge-based methods. However, such approaches have limitations in dealing with complex, yet short and sparse, data that may be encountered on the web and do not engage in the complex synthesis that humans perform cognitively to achieve cohesive and coherent output.

While crowdsourcing has been shown to be effective, crowdsourcing system have not been systematically adapted to different domains. Crowdsourcing may be more effective when domain knowledge is injected into the crowdsourcing system. By injecting domain knowledge into the structure when needed, the crowdsourcing system does not require domain experts to complete the tasks. The system and methods disclosed herein relate generally to human cognitive task design for crowdsourcing, machine processing and summarization of multi-sourced unstructured data in the form of text or multimedia and allocating human cognitive tasks and machine learning tasks with respect to efficiency and accuracy resulting in high quality diagnosis and repair knowledge by using domain knowledge representation in the system design.

The servers 120 may host content that is related to the relevant domain. For example, there may be appliance or vehicle repair websites and forums that include detailed information regarding various repair and diagnostic techniques. The content may be unstructured in that there is no formal organization of the information. The knowledge base 112 may be improved by incorporating information related to a product or type of product from the servers 120. Some techniques may be described by the hosted content for similar products and these techniques may be adaptable to products for which the knowledge base 112 is being synthesized.

The systems and methods disclosed herein may be applied to applications that provide domain specific diagnosis and repair knowledge for products such as cars, heating systems, and home appliances. The diagnosis and repair knowledge can be made accessible on a web site or via a diagnosis tool (e.g., a scan tool used by technicians at automotive workshops). Disclosed herein are systems and methods adapted to design human cognitive tasks that are targeted to crowd workers 121 who do not necessarily possess extensive domain knowledge and to design machine processing/learning tasks with a domain knowledge representation to synthesize complex information for diagnosis and repair knowledge for a specific domain of interest. The disclosed systems and methods may decompose information synthesis tasks into multiple micro-tasks for crowd workers 121 and task processing machines 118. The decomposition may be configurable and/or dynamic. The systems and methods may be configured to update domain knowledge representations learned from earlier crowd workers outputs as well as machine processing outputs.

Systems and methods are disclosed herein to incorporate domain knowledge into the design of semi-crowdsourced ISS 100. The ISS 100 may be configured to output a knowledge base 112 for diagnosis and repair of a product. The ISS 100 may be configured to create or generate tasks that may be executed by humans 121 or machines 118. The generated tasks may be low-cognitive tasks for crowd workers 121 with no prior knowledge of repair and diagnosis related to the specific domain. The generation of low-cognitive tasks permits execution by a wider supply of crowd workers 121 as specialized domain knowledge is not necessary to complete the tasks.

The ISS 100 may be integrated with automated information processing capability. That is, the ISS 100 may be implemented on the computing system 102 that may be programmed to automatically process and generate information.

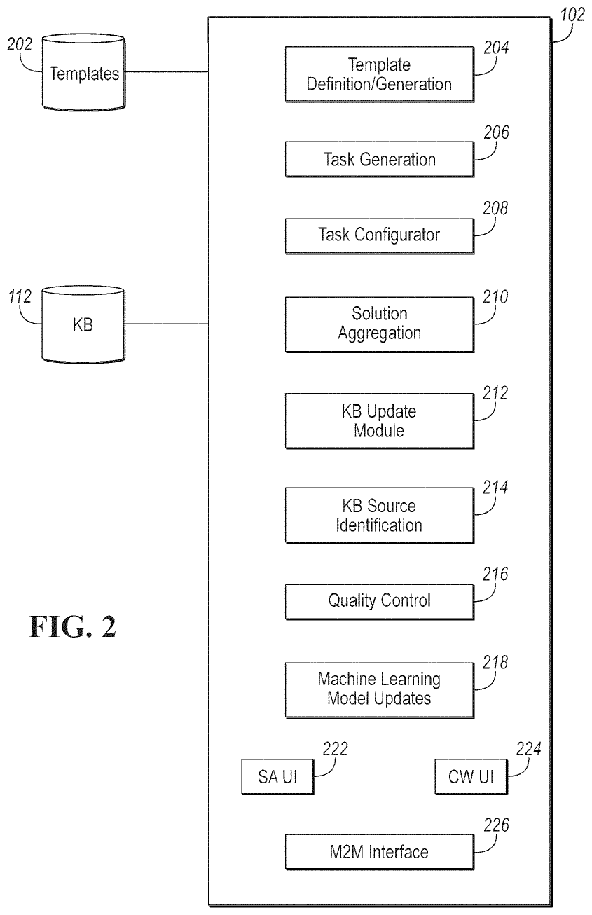

FIG. 2 depicts a block diagram of features or processes that may be implemented as part of the computing system 102. The processes described may interact with one another. Further, the processes may be updated by the system administrator 124. The processes may be stored in memory of the computing system 102 and executed periodically and/or when there is a demand for execution (e.g., inputs available and/or output needed). The computing system 102 may implement an operating system to manage task execution and sequencing.

The computing system 102 may include a task generation process 206. The task generation process 206 may be configured to define and generate tasks that are to be completed for updating the knowledge base 112. The tasks may define the specific data or knowledge that is to be sought from crowd workers 121 or task execution machines 118. The tasks may be defined as a request to perform a specific instruction to return information or data. The tasks may further define the format that data is to be returned. Tasks may be defined by the system administrator 124 based on the type of information being sought.

The computing system 102 may include a template definition/generation process 204. The ISS 100 may define one or more templates that include tasks for extracting information from text-based diagnosis and repair knowledge from humans 121 and/or machines 118. In some adaptations, the templates may be designed by system designers or administrators 124. In some adaptations, the templates may be automatically generated by a machine (e.g., local server 126). The template definition/generation process 204 may be programmed to facilitate the development of the templates. Templates and information related to the templates may be stored in a template database 202. The template definition/generation process 204 may be programmed to automatically generate templates. For example, the templates may include configurable fields related to a particular domain. The template definition/generation process 204 may be programmed to insert domain specific values derived from the knowledge base 112 into the configurable fields. A template may include one or more tasks that are to be completed by the task executor. For example, the tasks may be specific questions that are presented by the template.

The templates may be designed to subdivide larger tasks into smaller, more manageable tasks that can be performed by the crowd workers 121. Further, the tasks may be configured to generate low-cognitive tasks that can be completed by the crowd workers 121 without detailed expert knowledge. For example, the tasks may be directed toward summarizing or describing information that is found in an assigned source. The tasks may be in the form of short questions or multiple-choice questions.

The templates may include information and/or instructions for directing the crowd worker 121 in how to complete one or more tasks. The templates may include features for collecting information such as a symptom summary. The symptom summary may include data such as occurrence, location, and/or relevant conditions associated with the problem. The template may be configured to extract relevant product brands, models, model years, and other properties such as engine type or fuel type that identify a product. The template may be configured to extract a repair solution. For example, the repair solution may be formulated as <action verb> followed by <component of the object under repair>. The templates may be configured to utilize domain-specific terms and representations.

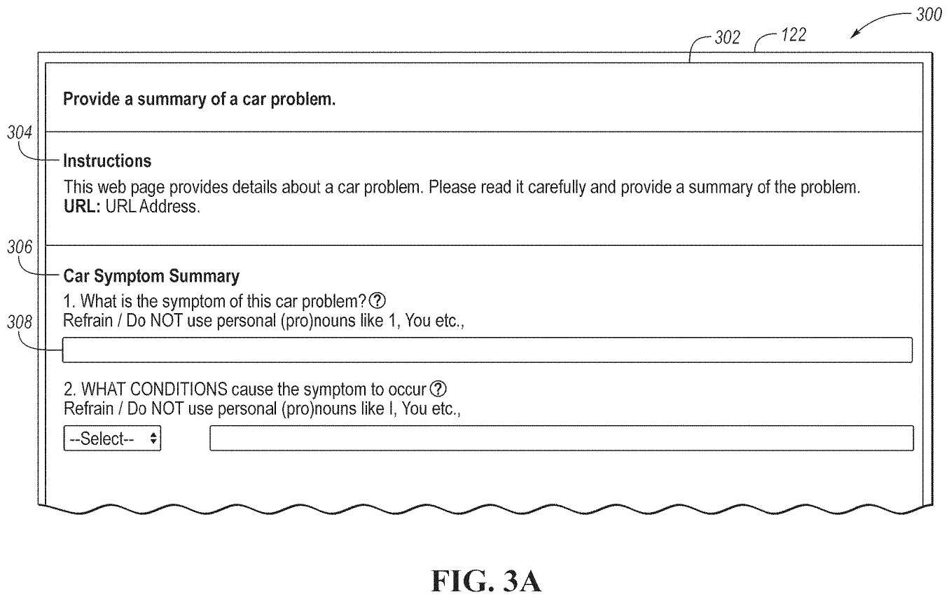

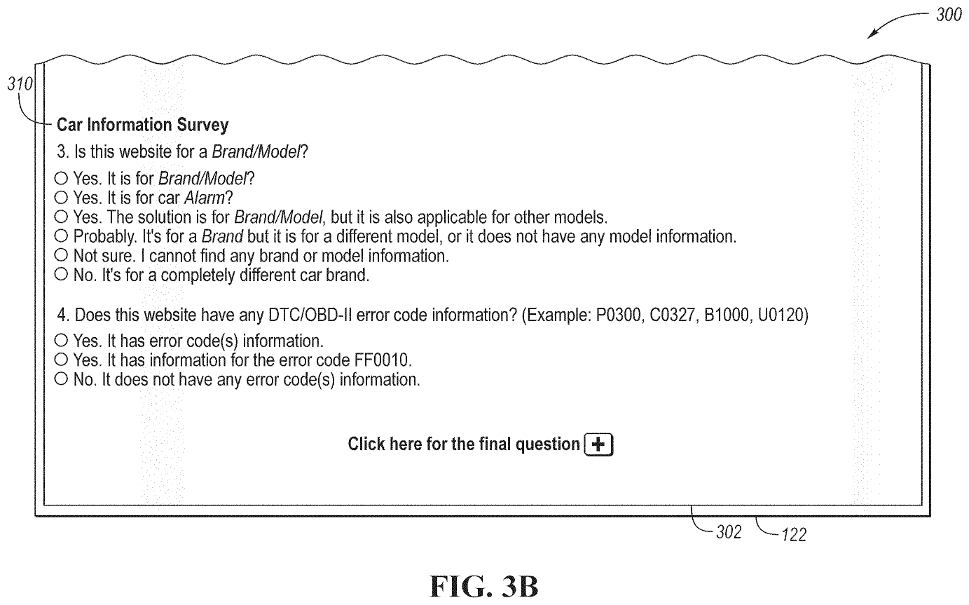

FIGS. 3A and 3B depict a possible display output 300 for a first example template 302. The first example template 302 may define a text-based interface. In some configurations, the first example template 302 (and other examples to follow) may be generated or defined as a Hypertext Markup Language (HTML) document (e.g., a web page). The first example template 302 may be displayed on a user interface or display of a workstation 122 of the crowd worker 121 that is assigned to complete the first example template 302. The first example template 302 may include an instruction section 304 for providing instructions to the crowd worker 121. In some applications, the instruction section 304 may include one or more links to websites or documents that are to be viewed and processed by the crowd worker 121. The instruction section 304 may also provide information to assist the crowd worker 121 in completing the task.

The first example template 302 may include one or more questions 306. The questions 306 may be specific queries for particular information (e.g., a symptom or condition). The questions 306 may incorporate domain-specific representations that are derived from previous task responses. The questions 306 that are presented may depend on responses from previous templates.

The first example template 302 may include one or more answer or input sections 308 for receiving inputs from the crowd worker 121. The first example template 302 may be configured to pose specific questions that the crowd worker 121 is expected to answer. The first example template 302 may be configured to receive text input from the crowd worker 121 via the input section 308. For example, the input section 308 may include a field or box for the crowd worker 121 to type text into. The input section 308 may also include predefined selection boxes that allow the crowd worker 121 to view a list of items and selection one or more of the items for input. The first example template 302 may also include a multiple-choice section 310 that may pose specific questions with corresponding check boxes to be selected by the crowd worker 121 in response. The questions 306 may be yes/no type questions and/or may be multiple choice questions. Upon completion, the first example template 302 may be submitted to the computing system 102 for further review and processing. The computing system 102 may be configured to automatically process the response or may be configured to store the response for later review by the system administrator 124. The templates may pose questions 306 to identify if the information relates to a specific brand, model, model years, and/or and other properties such as engine type or fuel type that identify a product. The templates may pose questions 306 intended to identify a specific component.

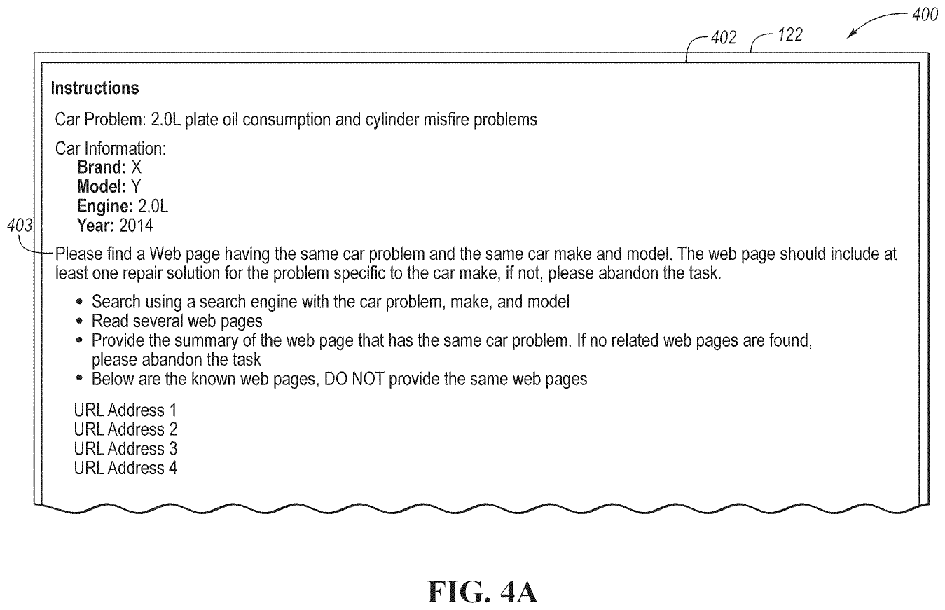

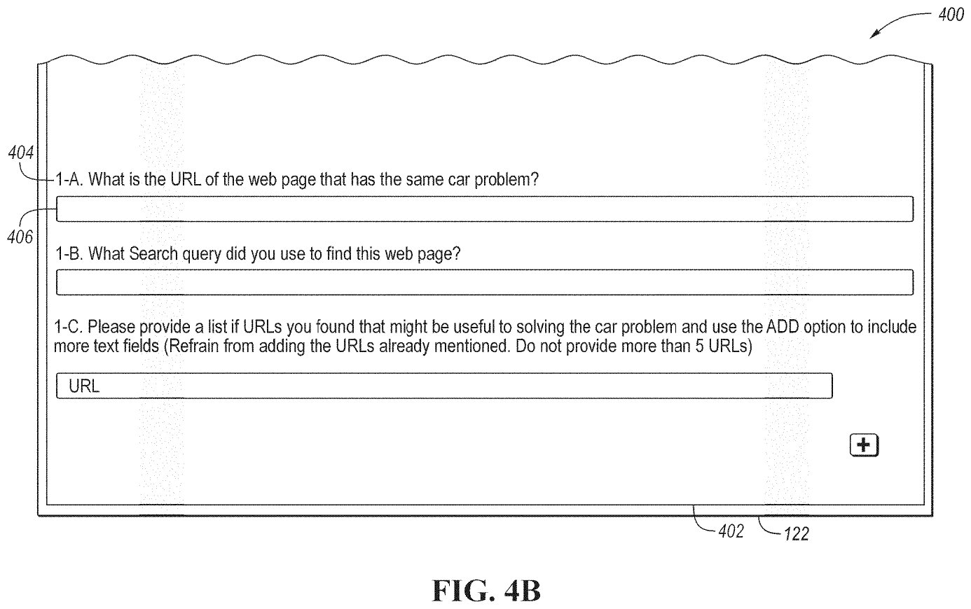

FIGS. 4A and 4B depict a second display output 400 for a second example template 402. The second example template 402 may be displayed on a user interface or display of a workstation 122 of the crowd worker 121 that is assigned to complete the second example template 402. The second example template 402 may define an instruction section 403. The instruction section 403 may define information that is relevant to completing the tasks associated with the second example template 402. For example, the second example template 402 may include a problem definition, specific product information, and specific instructions as to the output or response that is expected. The second example template 402 may request the task executor to search for a web page that is relevant to the defined problem. The second example template 402 may further provide a list of web pages that have already been submitted to reduce the chances of duplicate search results being submitted.

The second example template 402 may further include a specific request 404. For example, the specific request 404 may be for a URL that results from a requested search. The second example template 402 may further include a specific request response field 406 that is configured to allow the task executor to type or paste in the response to the specific request 404. The specific request response field 406 may be configured to accept text input from the work station 122. Additional request/response fields may be defined. For example, additional request/response fields may be configured to elicit the search terms that the task executor used.

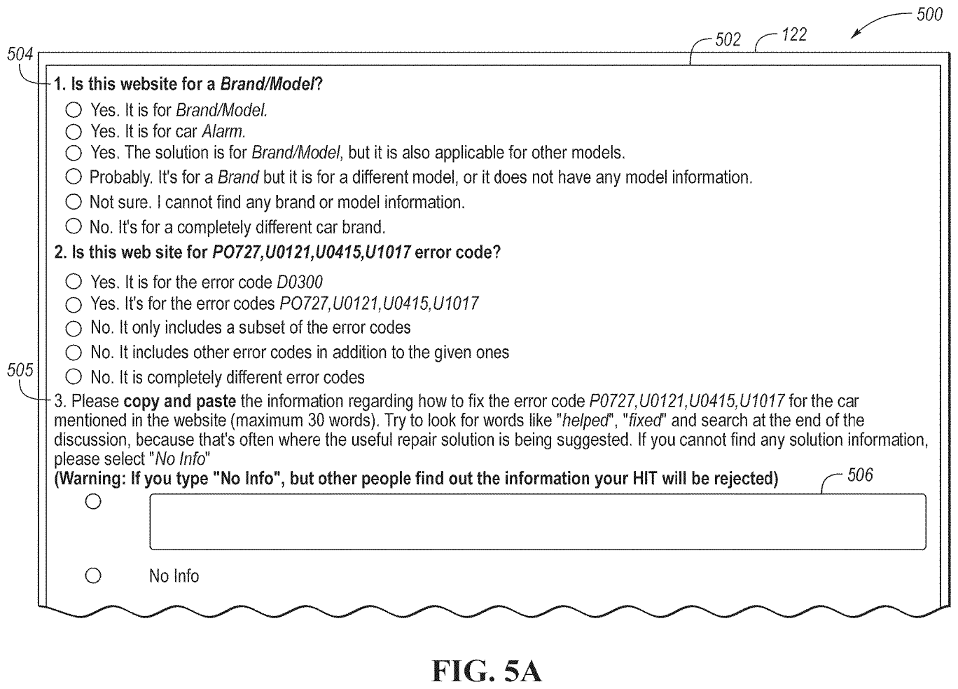

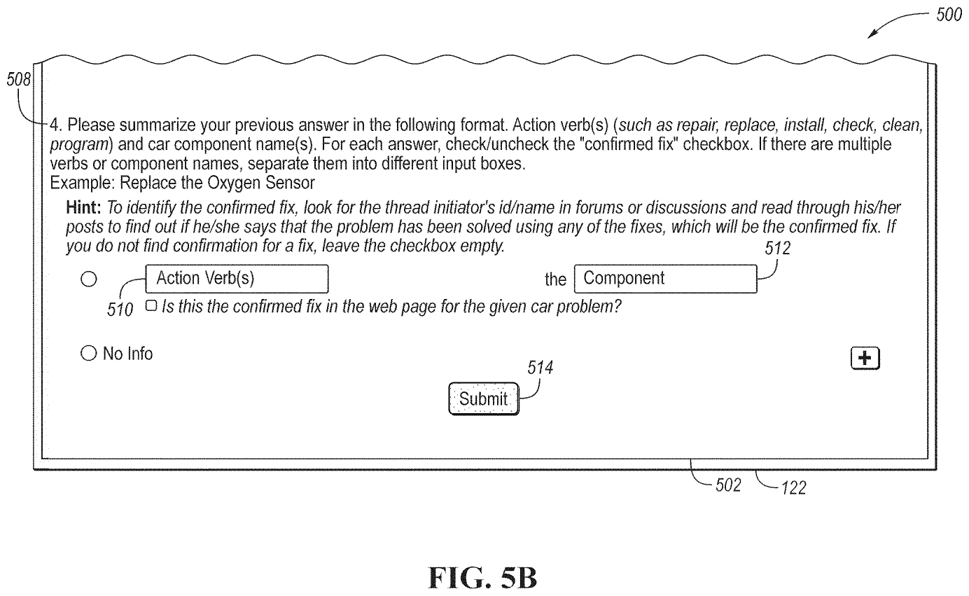

FIGS. 5A and 5B depict a third display output 500 for a third example template 502. The third example template 502 may be displayed on a user interface or display of a workstation 122 of the crowd worker 121 that is assigned to complete the third example template 502. The third example template 502 may include one or more multiple-choice sections 504. The multiple-choice sections 504 may state a question or statement followed by multiple possible answers with a corresponding check box or circle. The task executor may select one or more answers that apply to the question. For example, the question may be a specific question about a website (e.g., directed toward a specific product) or may be a specific question about a specific error code or problem. In some template definitions, the answers may be yes or no.

The third example template 502 may include an instruction statement 505 that provides instructions to the task executor. The instruction statement 505 may include specific domain knowledge or representations. For example, a diagnosis and repair application may reference specific error codes to guide the response of the task executor. The third example template 502 may include a response field 506 for inserting text or images in response to the instruction statement 505. The response field 506 may be configured to accept text or images that are pasted in. For example, the instruction statement 505 may request the task executor to copy information into the response field 506 relating to a solution for a specific error code that is suggested in a reference.

The third example template 502 may include a summarization request 508. The summarization request 508 may instruct the task executor to summarize a previous answer in a specific format. For example, the summarization request may instruct the task executor to state an action verb followed by a noun (e.g., component name). The third example template 502 may define an action verb input field 510 and a component name input field 512 that permit entry of text in response to the summarization request 508. In a diagnosis and repair application, the third example template 502 may further request information on whether the action identified by the response to the summarization request 508 is confirmed to solve or fix the associated problem.

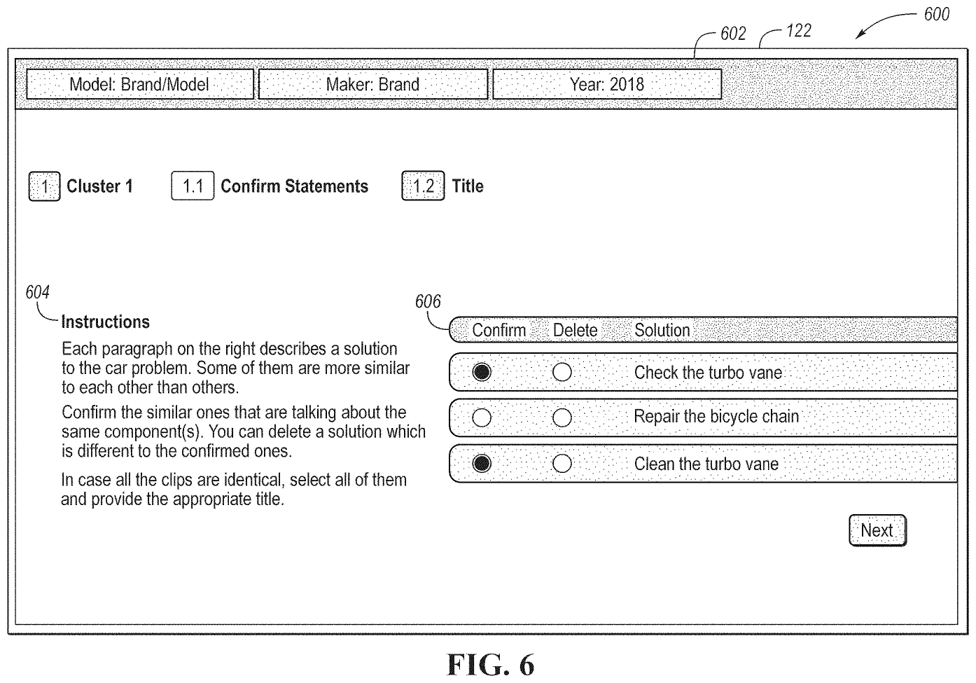

FIG. 6 depicts a fourth display output 600 for a fourth example template 602. The fourth example template 602 may be displayed on a user interface or display of a workstation 122 of the crowd worker 121 that is assigned to complete the fourth example template 602. The fourth example template 602 may be configured to present a plurality of solution statements 606. The fourth example template 602 may include an instruction field 604 to provide instructions to the task executor for completing the task. For example, the solution statements 606 may present a list of action verb/component combinations along with check boxes to confirm or delete each combination in the list. The instruction field 604 may instruct the task executor to select those combinations that are similar. In some configurations, the solution statements 606 may include at least one solution that is unrelated to the other solutions presented. The unrelated solution may be automatically inserted by the computing system 102 or may be manually inserted by a system administrator 124. The insertion of the unrelated solution may help to ensure that task executors are executing the tasks accurately. For example, a penalty scored associated with a task executor may be increased if the task executor selects the unrelated solution.

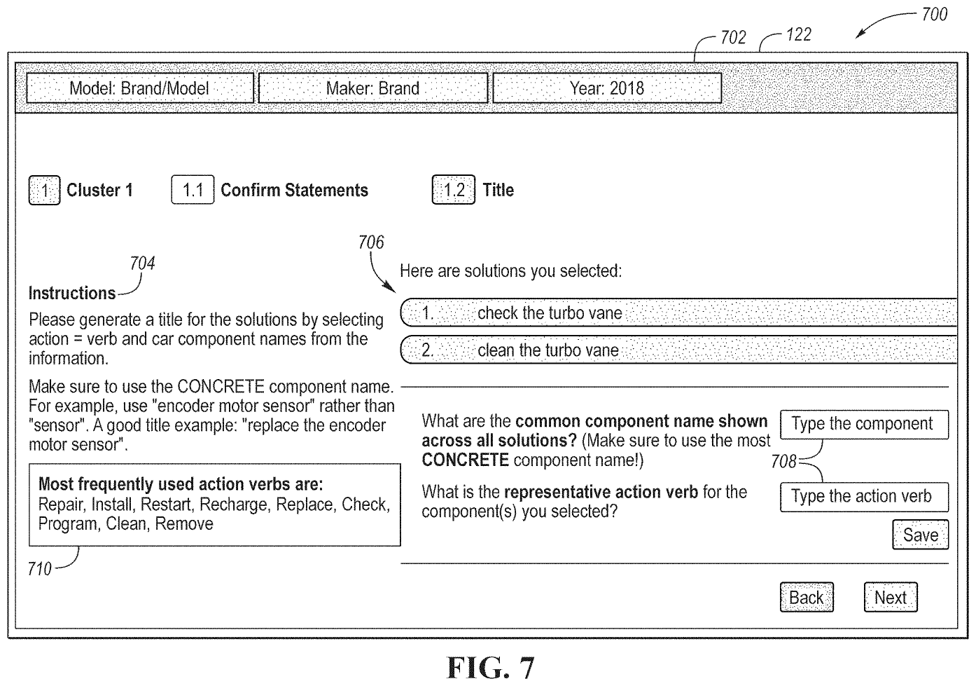

FIG. 7 depicts a fifth display output 700 for a fifth example template 702. The fifth example template 702 may be displayed on a user interface or display of a workstation 122 of the crowd worker 121 that is assigned to complete the fifth example template 702. The fifth example template 702 may be a follow-on task associated with the fourth example template 602. For example, the fifth example template 702 may be displayed in response to selecting a next button in the fourth example template 602.

The fifth example template 702 may include a selection solution summary 706 that lists the solutions selected from the fourth example template 602. The fifth example template 702 may include an instruction section 704 to provide instructions to the task executor for completing the task. For example, the instruction section 704 may instruct the task executor to generate a title for the solutions in the form of an action verb followed by the component name. The fifth example template 702 may include a suggestion field 710 that presents useful information to the task executor. For example, the suggestion field 710 may include a list of most frequently used action verbs. The frequently used action verbs may be derived from the knowledge base 112 and the suggestions may change over time as the knowledge base 112 is updated. The suggestion field 710 may help to ensure consistency in the information presented by the knowledge base 112. The fifth example template 702 may include one or more input fields 708 that are configured to receive data inserted by the task executor. For example, the input fields 708 may provide a field for typing in an action verb and a component name.

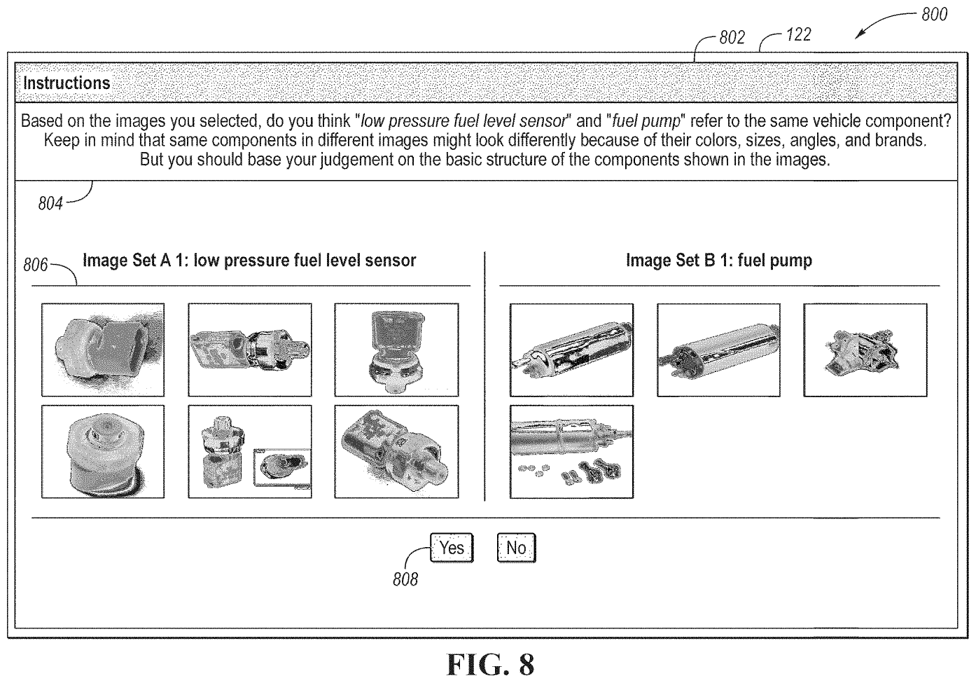

FIG. 8 depicts a sixth display output 800 for a sixth example template 802. The sixth example template 802 may be displayed on a user interface or display of a workstation 122 of the crowd worker 121 that is assigned to complete the sixth example template 802. The sixth example template 802 may include an instruction field 804 to provide instructions to the task executor for completing the task. The sixth example template 802 may include an image comparison field 806 that displays one or more images. The images may include different views of one or more components. The images may be derived from the knowledge base 112 as images associated with a particular component. The images may have resulted from the execution of previous tasks. For example, the instruction field 804 may present instructions for comparing one or more sets of images. In the example, images of a low-pressure fuel level sensor and a fuel pump are displayed, and the task executor is asked if the images represent the same component. The sixth example template 802 may include selection buttons 808 (e.g., yes and no) that may be used to indicate or record the answer of the task executor.

The template definition/generation process 204 may be configured to define one or more templates for extracting information from video-based diagnosis and repair knowledge from crowd workers 121 and/or machines 118. A video may be divided into a plurality of smaller segments (snippets) for processing. The video-based templates may include fields for extracting a start time of the video snippet, an end time of the video snippet, and a brief (e.g., one line) description of the video snippet.

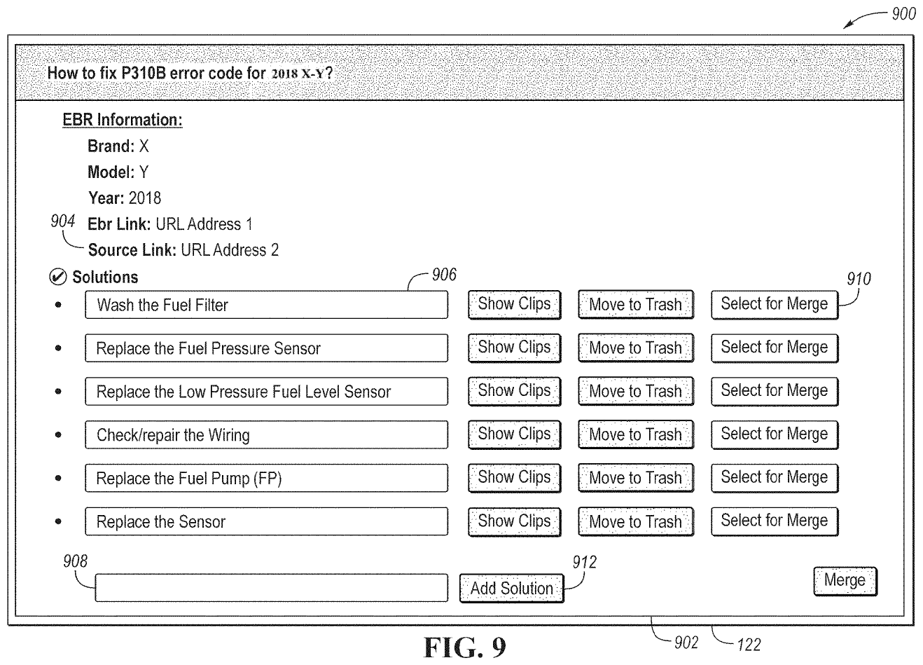

Some tasks/templates may be configured for processing by a domain expert 130. The domain expert 130 may be able to inject domain knowledge into the task pipeline to ensure that the knowledge base 112 contains relevant information. In addition, the domain expert 130 may filter and combine results from the crowder workers 121. FIG. 9 depicts an seventh display output 900 of a seventh example template 902. The seventh example template 902 may be displayed on a user interface or display of a workstation 122 of the domain expert 130 that is assigned to complete the seventh example template 902. The seventh example template 902 may include a link 904 to an information source (e.g., website/webpage). For example, the information may be a forum related to the product. The domain expert 130 may be prompted to merge solutions that were previously identified from previous task executions. The seventh example template 902 may include an add solution interface that includes an add solution button 912 and a solution entry field 908 that allows the reviewer to enter a new instruction or description. The seventh example template 902 may include a select for merge interface 910 (e.g., virtual button) that allows the task executor to select items to merge. For example, solutions may be identified as “Replace the Fuel Pressure Sensor”, “Replace the Low-Pressure Level Fuel Sensor”, and “Replace the Sensor”. The task executor may recognize that these solutions are the same and select them for merging into a single solution. The seventh example template 902 may include a selection to delete (e.g., Move to Trash) a solution or show additional information (e.g., Show Clips) related to a solution.

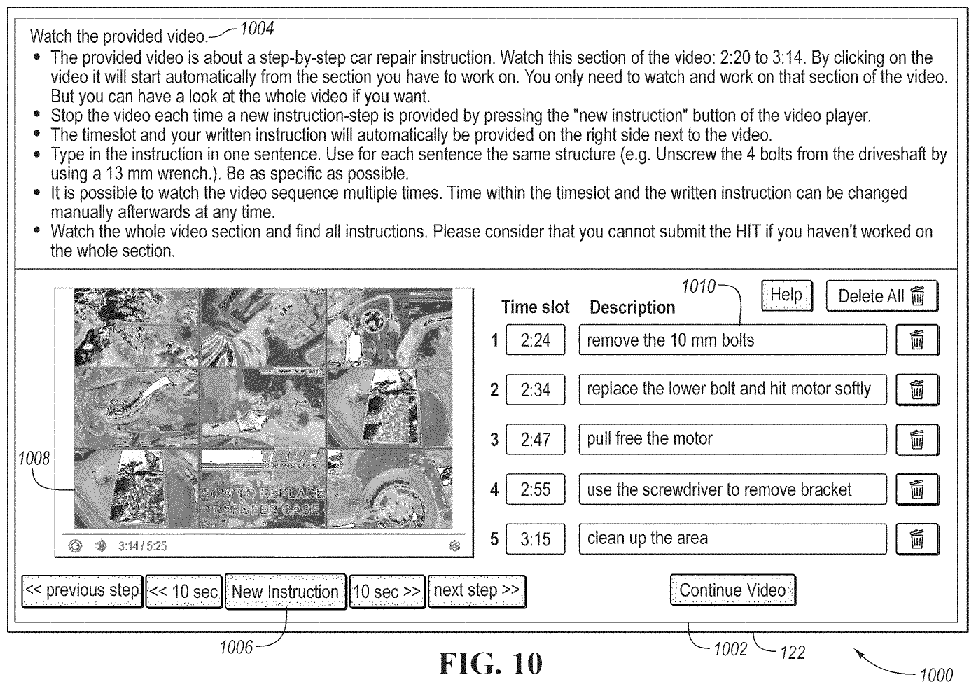

FIG. 10 depicts an eighth display output 1000 of an eighth example template 1002. The eighth example template 1002 may be displayed on a user interface or display of a workstation 122 of the crowd worker 121 that is assigned to complete the eighth example template 1002. The eighth example template 1002 may include an embedded video 1008 or a link to a video that is to be processed by the crowd worker 121 or machine 118. For example, the video 1008 may be an instructional video including step-by-step repair or diagnostic instructions for a specific product or system. The crowd worker 121 may be prompted by an instruction section 1004 to segment the video 1008 according to instruction steps or logical segments defined by the video 1008. The eighth example template 1002 may include a new instruction interface 1006 or button that allows the task executor to enter a new instruction or description into a newly created description field 1010. The eighth example template 1002 may be configured to record an elapsed time within the video 1008 when the new instruction interface 1006 is selected to associate the elapsed time with the new instruction. In this manner, the video 1008 may be summarized and the instructional steps documented. When completed, the template may be submitted to the computing system 102 for further review and processing.

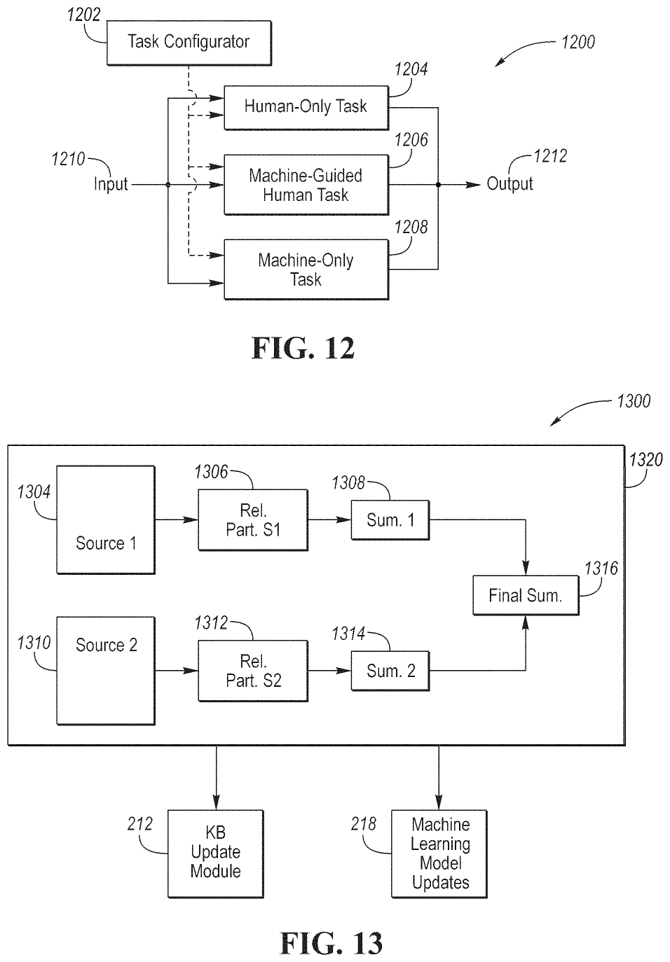

Referring again to FIG. 2, the computing system 102 may include a task configurator process 208. The task configurator process 208 may be configured to distribute the tasks and/or templates to one or more task executors. Task executors may include the crowd workers 121 and the task processing machines 118. The task configurator process 208 may be further configured to automate task distribution with respect to accuracy and capability of crowd workers 121 and task processing machines 118. The task configurator process 208 may be configurable to distribute differently designed tasks that process the same inputs and produce a same format of output. The task types may include human-only tasks, machine-guided human tasks and machine-only tasks (see FIG. 12). The system may be configurable to execute multiple tasks with a single type in parallel or sequentially, or with a combination of different task types in parallel or sequentially.

FIG. 12 depicts an example of a task configurator process 1202 and the different types of tasks that may be present. A human-only task 1204 may be defined that is intended to be assigned to and performed by one or more of the crowd workers 121 and/or domain experts 130. For example, a task in the workflow may be defined to group similar information from multiple sources into a single group and provide a title for the group in a template (e.g., ‘action verb’ the ‘component name’). The task may be defined as a human-only task that provides a graphical user interface to a human (e.g., crowd worker 121) to request selection of similar information from a full list and then request insertion a title of the grouped sentences. Some tasks may require processing by the domain experts 130. Different types of tasks may be distinguished by the level of domain knowledge required. The task configurator process 1202 may determine the knowledge level and assign the task accordingly.

A machine-only task 1208 may be defined that is intended to be assigned to and performed by one or more of the task processing machines 118. For example, a task may be defined as a machine-only task in which machine processes are designed to receive a number of sentences or phrases and group the sentences based on a prediction accuracy score.

A machine-guided human task 1206 may be defined that is intended to be assigned to and performed by a combination of the crowd workers 121 and the task processing machines 118. For example, a task may be defined as a machine-guided task in which a task processing machine 118 processes an initial grouping of sentences, then crowd workers 121 validate the machine-processed results and provide a title by interacting with the system via a graphical user interface.

Tasks of the system may be pluggable or exchangeable such that tasks of different types (e.g., human, machine, machined-guided) may be exchanged for one another. The different types of tasks may be defined to receive one or more inputs 1210 and generate one or more outputs 1212 using a common format. For interchangeable tasks, the inputs 1210 for each of the tasks may be the same and the outputs 1212 may be the same. The task configurator process 1202 may then select a task executor for each task. For example, an existing human-only task may be replaced with a new machine-guided task or machine-only task without upsetting the workflow. The exchange between types may be dynamically determined. The task configurator process 1202 may be configured to dynamically switch between task types depending on the availability and accuracy of the machine or crowd worker processed information. The task configurator process 1202 may assign tasks based on the availability of each of the task types. For example, some tasks may exist as a human-only task 1204 without a corresponding machine-only task 1208. Over time, additional machine-only tasks may be developed and can be easily inserted into the workflow. A task may be assigned to each type of task executor to compare outputs. This can be used to validate the outputs of the different task executors. When a task is validated it can be used in the workflow. The task configurator process 1202 may assign tasks to the most efficient task executor (e.g., fastest task executor that provides a certain level of accuracy).

The task configurator process 1202 may implement a probabilistic model to predict the accuracy of each task type in advance of task distribution and a probabilistic model to validate the output from each task performed. The task configurator process 1202 may determine a workflow of tasks (e.g., distribution of tasks) based on the prediction from the models to optimize quality and efficiency. The task configuration and selection may also be changed manually by system administrators 124 or automatically based on rules/algorithms programmed into the task configurator process 1202.

Referring again to FIG. 2, the computing system 102 may include a solution aggregation process 210. The solution aggregation process 210 may be configured to aggregate the solutions received from the task executors. The solutions may be responses provided by the task executors in the templates. For example, data inserted into the templates by the task executors may be processed and compared to outputs of similar tasks or templates. Some tasks may be sent to multiple task executors for completion. In some cases, similar tasks may be generated and assigned to ensure that the solutions are consistent among the task executors. The solution aggregation process 210 may compare solutions to determine if additional tasks should be generated to combine or further validate the solutions.

The computing system 102 may include a knowledge base update process 212 that is configured to update information in the knowledge base 112 with the solutions provided by the task executors. For example, the knowledge base 112 may be configured to include a library of domain-specific terms or domain-specific representations. A component may be described by different labels or descriptions in different sources. It may be useful to capture the various representations in use for each component. For example, an oxygen sensor may appear in different sources as “O2 sensor” or “Lambda sensor”. The knowledge base update process 212 may be configured to update the knowledge base 112 with the different domain-knowledge representations. Awareness of the different representations may result in more relevant search results and may aid in uncovering additional sources to mine for data. The knowledge base update process 212 may implement natural language processing algorithms to compare knowledge representation from the knowledge base 112 with those provided in the solutions. The knowledge base update process 212 may be programmed to identify two compound nouns as potential synonyms of each other responsive to the nouns satisfying predetermined criteria. The criteria may include an image search engine providing more than a predetermined number of common URLs in response to a search using the different terms. The criteria may include the nouns completely matching each other except for the ending word and the ending word representing collections. The criteria may include all unigrams of the two nouns being the same. The criteria may include unigrams of one noun being a subset of the other and the ending words of the two nouns being the same and being a generic word. The process of identifying different domain knowledge representations may be facilitated by designing one or more tasks to compare terms with presented images (e.g., FIG. 8).

The computing system 102 may include a knowledge base source identification process 214. The knowledge base source identification process 214 may be configured to identify source material that is relevant to the knowledge base 112. The knowledge base source identification process 214 may be configured to monitor the solutions provided by task executors for additional domain knowledge representations. For example, the domain-knowledge representations may suggest additional search terms to identify web-based sources that include the updated domain-knowledge representations. The knowledge base source identification process 214 may be automated and/or directed by the system administrators 124.

The computing system 102 may include a quality control process 216 that is configured to assess and predict the quality of solutions and task executors. The quality control process 216 may implement methods to improve the quality control of tasks performed by crowd workers 121 by injecting domain knowledge. Various strategies may be implemented such as gold standard, majority voting and predict. The quality control process 216 may be configured to assess the accuracy of a given solution and the accuracy of the task executors. The quality control process 216 may also monitor the timeliness of task executors in providing the solutions. The timeliness may be determined as the time from task assignment to task completion. The quality control process 216 may be configured to validate task results and responses. The quality control process 216 may implement strategies to predict accuracy of the task executors prior to distributing the tasks and templates.

The quality control process 216 may be configured to manage the quality of the crowd workers 121 by implementing a worker profile management feature. The quality of each crowd worker 121 may be dynamically calculated during a task evaluation or review. The quality profile of a crowd worker 121 may include a total penalty score for all task types and an individual task penalty score for each task type. The penalty score may be calculated based on the number of tasks with correct answers across a total number of task submissions, correctness of gold standard tasks, an agreement rate of answers amongst different crowd workers 121 for the same task, and sampling evaluation of tasks. Based on the penalty scores, the task configurator process 208 may be configured to withhold assignment of tasks to a worker temporary or permanently.

The quality control process 216 may be configured to maintain a penalty score for each of the task executors. The penalty score may be used by the task configurator process 208 to assign tasks to the task executors. The task configurator process 208 may be programmed to distribute tasks to the task executors responsive to the corresponding penalty score being less than a predetermined penalty threshold. The predetermined penalty threshold may be a value indicative of the task executor providing quality output. A penalty score exceeding the predetermined penalty threshold may be indicative of poor quality output by the task executor. The task configurator process 208 may be programmed to withhold or prevent distributing tasks to a task executor with a corresponding penalty score that exceeds the predetermined penalty threshold. The quality control process 216 may increase or decrease the penalty score corresponding to each of the task executors.

Quality may be assessed based on crowd and machine collaborated quality control mechanisms. Quality may be assessed by a validation of human input with a Machine Learning model with domain knowledge. A Machine Learning model may be defined as a virtual crowd worker for consensus in situations in which quality prediction may be difficult.

The computing system 102 may implement a method to represent a ranked list of repair solutions with respect to source accuracy prediction and accuracy prediction of the output of the task executors (crowd worker, machine, domain expert). For example, solutions from task executors having higher predicted accuracy values may be placed more prominently in a list. The quality control process 216 may calculate source accuracy prediction based on proposed solutions from layman, proposed solutions from experts, confirmation of fixing the problem with proposed solution, proposed solution based on guess, proposed solution based on the solution that fixed an identical or similar problem that occurred earlier, and the number (occurrences) of redundant solutions from multiple sources of information.

The quality control process 216 may further implement a scammer identification strategy. A scammer may be a worker that is not performing properly. For example, a scammer may be motivated to minimize the amount of work performed while maximizing the amount of compensation received. The scammer may purposely submit inaccurate information without spending an appropriate amount of time on an assigned task. The quality control process 216 may be programmed to identify the scammer and stop assigning tasks to the identified scammer.

The quality control process 216 may implement a method to identify scammers within crowd workers for repair and diagnosis summarization. For example, a task solution for text summarization may be monitored to identify scammers. The penalty score for a task executor may be increased to a value greater than the predetermined penalty threshold responsive to receiving more than a predetermined number of responses from the task executor that are the same for different tasks (e.g., crowd worker providing the same solution to multiple repair questions). The corresponding task result or response may be invalidated or quarantined. Invalidated responses may not be processed further. Quarantined responses may be stored for possible use later pending further results from the same task executor.

The quality control process 216 may compare domain-specific representations in a provided solution and an original source. The penalty score for a task executor may be increased to a value greater than the predetermined penalty threshold responsive to the task executor providing more than a predetermined number of responses to tasks that contain domain-specific representations that are not present in an original source associated with the tasks (e.g., the crowd worker provides solutions containing components that are not present in the original document multiple times). The penalty score may increase above the predetermined penalty threshold if the criteria is satisfied for more than a predetermined number of tasks. The corresponding task result or response may be invalidated or quarantined.

The penalty score for a task executor may be increased to a value greater than the predetermined penalty threshold responsive to the task executor providing more than a predetermined number of responses that are unique compared to responses submitted by other task executors to a same task (e.g., the crowd worker provides unique solutions that no other crowd workers provided multiple times). The penalty score may increase above the predetermined penalty threshold if the criteria is satisfied for more than a predetermined number of tasks. The corresponding task result or response may be invalidated or quarantined.

The criteria for increasing the penalty score are indicative that the crowd worker did not properly complete the task. In configurations with video summarization, the penalty score may increase responsive to the task executor finishing a video-summarization task in a time that is less than a predetermined percentage (e.g., half) of a runtime of an assigned video segment (e.g., a crowd worker finishes the task within less than half of the total length of the video). The video-summarization task may be invalidated responsive to a task completion time being less than a predetermined percentage of a duration of the portion of the video that is the source. This is indicative that the crowd worker did not view the entire video snippet associated with the task.

The quality control process 216 may decrease the penalty score under certain conditions. For example, submission of responses that do not satisfy the penalty criteria may cause the penalty score to be decreased. For example, providing solutions that are validated by another source may cause the penalty score to decrease. The rate of increase and decrease of the penalty score may be different.

The computing system 102 may include a system administrator user interface process 222. The system administrator user interface process 222 may be configured to facilitate management of the ISS 100 by the system administrators 124. The system administrator user interface process 222 may include a display interface for viewing information related to the knowledge base 112. The system administrator user interface process 222 may include interfaces for creating and managing templates and tasks and reviewing solutions provided by task executors.

The computing system 102 may include a crowd worker user interface process 224 that may be configured to facilitate task completion by the crowd workers 121. The crowd worker user interface process 224 may include interfaces that enable crowd workers 121 to view and enter solutions into templates. For example, the crowd worker user interface process 224 may define a web-based interface for task completion.

The computing system may include a machine-to-machine interface process 226 that is configured to manage interaction with the task processing machines 118. The machine-to-machine interface process 226 may implement communication protocols between the computing system 102 and the task processing machines 118. The machine-to-machine interface process 226 may distribute programs for execution on the task processing machines 118.

The ISS 100 may further include a feature for editing/reviewing diagnosis and repair solutions. The feature may include user interface (UI) and software components that represent data processing traces of original sources, extracted information, summarization and grouping similar solutions through the template.

The computing system 102 may include a machine learning model update process 218 that is configured to manage creation and training of machine learning models. The machine learning model update process 218 may be configured to increase efficiency through machine learning by repurposing knowledge obtained from earlier execution through a multi-step validation process. The machine learning model update process 218 may be updatable to permit creation and injection of new machine tasks that are designed offline into the workflow.

Domain knowledge representation may be updated using a chain of data (e.g., trace of data by backtracking). For example, the system initially may have domain knowledge representation of car components with a representative component name (e.g., oxygen sensor), acronyms (e.g., o2 sensor), and/or synonyms (e.g., Lambda sensor). By processing information through tasks, the system can learn and update informal usages (e.g., o2s) or frequent spelling mistakes (e.g., 02 sensor in which an alphabetic o is replaced by the number zero) of terms that refer to the same car component. The machine learning model update process 218 may be configured to learn the new knowledge by maintaining a trace/record of the original information, the summarized information, and the group/cluster of multiple summarization that results in the final solution/answer for the summarized problem.

FIG. 13 depicts a possible block diagram 1300 showing data that may be maintained as part of a trace database 1320. The trace database 1320 may be non-volatile memory storage for saving the chain of data in the workflow. The trace database 1320 may include a first source 1304 and a second source 1310. The first source 1304 and the second source 1310 represents the original source data or links to the original source data. As described previously, the original sources are processed to obtain relevant parts. The trace database 1320 may include a first relevant part 1306 that is derived from the first source 1304. The trace database 1320 may include a second relevant part 1312 that is derived from the second source 1310. As described previously, the relevant parts may be summarized. The trace database 1320 may include a first summary 1308 that is derived from the first relevant part 1306. The trace database 1320 may include a second summary 1314 that is derived from second relevant part 1312. As described previously, the summarized parts may be combined and grouped resulting in a final summary or title. The trace database 1320 may include a final summary 1316 that is derived from the first summary 1308 and the second summary 1314. FIG. 13 depicts a final summary that is a combination of two original sources. Note that the trace database 1320 may include many such data structures. For example, multiple relevant parts may be derived from an original source and result in additional final summaries. The trace database 1320 may represent a chain or trace of the components that result in the final domain knowledge representations. Each task or template may be associated with a corresponding element within the chain or trace. Maintaining a trace of the components further allows later analysis that may be helpful in redesigning or automating the workflow.

The trace database 1320 may provide information to the KB update module 212. For example, the final summary 1316 may be provided to the KB update module 212. The KB update module 212 may search the final summary 1316 to determine if it contains information that is not present in the knowledge base 112. The KB update module 212 may update the knowledge base 112 with domain knowledge representations such as component names, dictionary items, symptoms, error codes and repair information. The update of domain knowledge may be automated by machine or semi-automated (e.g., newly discovered information is reviewed/confirmed by a domain expert before permanently being used as updated domain knowledge).

The trace database 1320 may provide information to the machine learning model updates process 218 for updating machine learning models. The machine learning model update process 218 may be configured to create new machine learning models by using the chain of data traced in different tasks of the workflow. For example, a collection of the relevant parts (e.g., first relevant part 1306 and second relevant part 1312) selected from of an original source of information (e.g., first source 1304 and second source 1310), the associated summaries (e.g., first summary 1308 and second summary 1314), and the final summary 1316 may be input as training data for new machine learning algorithms. The chain of data includes the input (e.g., original source) and final output (e.g., final summary) that can be used to train the machine learning models. For example, the machine learning model may be executed repeatedly with the training inputs. The machine learning model outputs may be compared to the expected outputs to determine an error. Weighting factors or gains within the machine learning model may be adjusted responsive to the error. The process may be repeated until the error is below a predetermined magnitude.

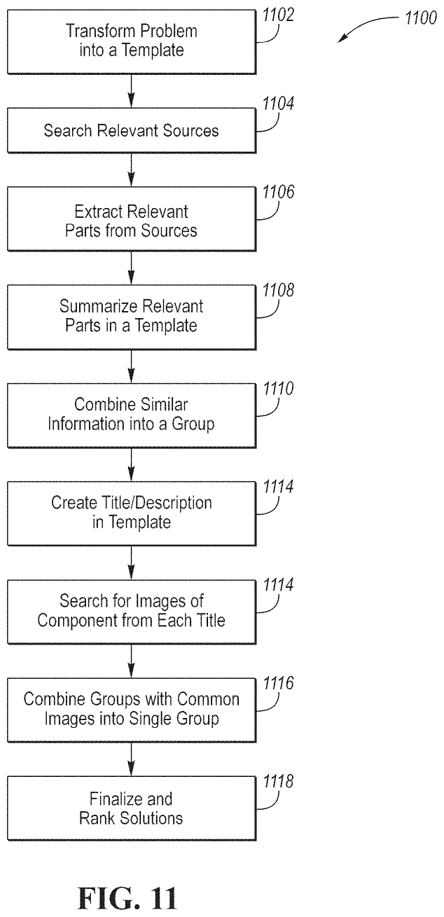

The information processing workflow may include a number of tasks or processes as depicted in FIG. 11. FIG. 11 depicts a possible set of steps or tasks for a summarization workflow 1100. Each step or task may be performed by human (e.g., crowd worker 121) or machine (e.g., task processing machine 118).

At task 1102, operations may be performed to transform the original problem description from a diagnostic/scan tool or information system into a template. The template may define one or more tasks that are to be completed. The operation may be performed by system administrators 124 or by a software program or application. In later stages of information synthesis, the operation may be automated by a machine. For example, an original problem description may be related to an error code related to a product. The error code may be read from a diagnostic tool or displayed or indicated by the product itself. A template may be created that attempts to extract information related to the specific error code. Question such as “What causes error code X for a product Y?”, “How to fix error code X for product Y?”, or “How to diagnose error code X for product Y?” could be presented.

At task 1104, operations may be performed to search relevant information sources. The search may be directed using search terms that are related to existing domain-specific representations. Initial searches may reveal additional domain-specific representations which may be used to direct additional searches. Relevant information sources may include web-sites and/or web pages. The sources may be unstructured data sources. An unstructured data source may not have a logical order or presentation of information. For example, a web-based discussion forum is ordered by responses or posts. To extract useful information, each post or response must be parsed. The posts or responses may not always supply relevant information. The search process may yield one or more sources that are relevant to the original problem. For example, one or more web addresses may be identified and stored. The web addresses may be incorporated into templates. FIGS. 4A and 4B provide one possible example of a template that may be created to facilitate the searching.

At task 1106, operations may be performed to extract the most relevant data from the selected source. A template may be created to identify the selected source and request a review to determine sections that are relevant to the original problem. FIGS. 3A and 3B provide a possible example of a template that may facilitate extracting information from a source. The relevant data may include those portions of the source that are most applicable to the original problem definition. For example, the source of information may include additional information that is not relevant to the problem. The task output may be an identification of the relevant portions for later processing. For example, a specific paragraph or section may be identified. The template may ask specific questions to facilitate extraction of relevant information.

At task 1108, operations may be performed to summarize the relevant data in a template. Templates may be created to request a summary of the relevant section of the source. For example, the template/task assigned to a crowd worker 121 may provide instructions for summarizing the relevant data in a predetermined format as described previously. The crowd worker 121 may process the task and provide the requested summary. Multiple tasks may be distributed that identify different sources and/or different relevant sections. FIGS. 5A and 5B provide a possible example of a template that may be created for summarizing data.

At task 1110, operations may be performed to combine similar information into a group. The task results may be analyzed to determine if there is similar information that can be grouped together. Templates may be created to produce tasks to facilitate identification and grouping of similar information. Templates may produce a list of similar information and the task executor may be assigned to identify the similar information. FIG. 6 and FIG. 9 provide possible examples of templates for facilitating combining or grouping data.

At task 1112, operation may be performed to create a title/short description in the template. The task executer may review the grouping of information and provide a title or description in <action verb><noun> format. FIG. 7 provides a possible example of a template for facilitating title generation.

At task 1114, operations may be performed to search for images for the component for each solution title. A template or task may be created to cause a search for images of the component associated with the title/description.

At task 1116, operations may be performed to combine groups having common images into a single group. The images may be reviewed to determine if any groups are associated with a common image. Tasks/templates may be created to request analysis of a set of images. For example, a task may request that the task executor identify images as being of the same component. FIG. 8 provides a possible example of a template for image identification and combination.

At task 1118, operations may be performed to finalize and rank the solutions. Operations may be performed to rank the final solutions. The penalty score may be used to rank solutions based on the provided solutions and/or the past performance of the task executor. Highly ranked solutions may be incorporated into the knowledge base 112. Lower ranked solutions may spawn additional tasks for further validation.

The workflow of FIG. 11 depicts one way of processing the information reduce a set of unstructured data into a set of targeted domain knowledge in a common and consistent format. The workflow may be facilitated by the templates that identify specific, manageable tasks that can be completed by the task executors. The workflow may be similar for many products. The templates may be adjusted to use the domain-specific representations for a given product. The workflow may be performed to generate the domain-specific knowledge base for any product or system.

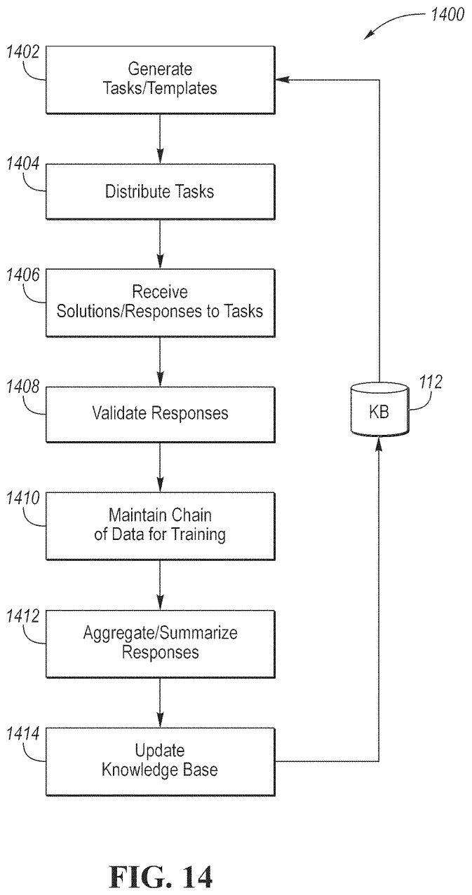

FIG. 14 depicts a possible sequence of operations that may be performed by the ISS 100. Operations may be performed by the computing system 102 and/or the system administrators 124 depending upon the level of automation that is implemented. At operation 1402, tasks and templates may be generated. For example, domain-specific representations may be inserted into a blank or generic template. In some configurations, the tasks and templates may be reviewed by the system administrator 124. The templates may be generated using information that is currently in the knowledge base 112. The computing system 102 may identify domain-knowledge representations that are currently absent from the knowledge base 112 from previous task results and generate templates defining tasks that include the domain-knowledge representations for extracting information from unstructured sources.

At operation 1404, the tasks/templates are distributed to the task executors. The computing system 102 may maintain data regarding the quality of task executors that interact with the ISS 100. The computing system 102 may distribute task/templates based on an availability of the task executors and an accuracy of the task executors. The computing system 102 may prioritize assignment of the tasks to task executors having the highest quality designation. In addition, the computing system 102 may maintain scheduling information regarding the task executors. For example, the computing system 102 may maintain data regarding outstanding tasks assigned to the task executors. The computing system 102 may determine the work load of each task executor to determine if the task executor has capacity to perform the task before an assigned deadline. The computing system 102 may also determine the type of task (e.g., human-only or machine-only) that should be assigned. For example, the computing system 102 may check for the availability of machine-only task that can complete the task to be assigned. In some cases, the computing system 102 may determine that a task should be distributed to multiple task executors to obtain more solutions that may be combined. When the task executor is determined, the computing system 102 may post the task to the task executor in an appropriate manner via the corresponding interface.

At operation 1406, the computing system 102 may receive the solutions/responses to the tasks. For example, the task executors may have completed the appropriate input fields in a template. At operation 1408, the computing system 102 may validate the responses. For example, the computing system 102 may compare the submitted response to other similar responses. The computing system 102 may perform the quality control processes to determine if the response appears to be valid. The computing system 102 may update quality control designations for the task executors as part of the validation process. A response may be rejected if the quality control checks are not passed. A rejected task may be sent back to the task executor or may be sent to system administrators 124 for further review and action.

At operation 1410, the computing system 102 may update the chain of data for machine learning training. For example, the computing system 102 may update the trace database 1320 with the relevant information associated with task. The computing system 102 may identify the tasks that are associated with each piece of information. For example, multiple tasks may be used to create the chain from original source to the final summary information. The computing system 102 may associate each of the tasks with the corresponding piece of data.

At operation 1412, the computing system may aggregate and summarize the responses. The computing system 102 may be programmed to process the responses to combine similar responses. Further, the computing system 102 may implement natural language processing routines to combine similar response data. For example, for summary data that is expressed as an action verb and a noun, the computing system 102 may compare the responses for similar-meaning words and combine the responses using a preferred word. A word may be a preferred word if it appears in the knowledge base more than a predetermined number of times and/or more than other similar-meaning words.

At operation 1414, the computing system 102 may update the knowledge base 112. For example, the computing system 102 may identify that a piece of information is not currently in the knowledge base 112. The computing system 102 may then update the knowledge base 112 to include the new information. When new information is discovered, the computing system 102 may determine if additional tasks are needed. For example, the responses may have generated an alternative name for a component. Additional knowledge may be obtained by searching for information based on the alternative name. In this manner, additional knowledge may be uncovered and added to the knowledge base 112.

The information synthesis system described facilitates the creation of a knowledge base that pertains to a product or system. The knowledge base can be generated based on existing information using workers that are not domain experts. This results in lower costs for generating the knowledge base. Further, the system is easily adaptable to processing new information. For example, new domain-related terms or representations that occur can be used to search and create additional pieces of information for the knowledge base. Further, the templates that define the tasks may be similar for different products. The templates may be easily adapted to other products by changing the domain-specific representations and terms.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An information synthesis system for generating a knowledge base comprising:
a computing system programmed to distribute templates including tasks for extracting information from unstructured sources to task executors, receive task results from task executors as responses in the templates, identify domain-knowledge representations that are present in the task results but are absent from the knowledge base, generate templates defining the tasks and including the domain-knowledge representations for extracting additional information from unstructured sources.

2. The system of claim 1 wherein the tasks are defined as human-only tasks, machine tasks, and machine-guided tasks.

3. The system of claim 1 wherein the computing system is further programmed to distribute the templates based on an availability of the task executors and an accuracy of the task executors.

4. The system of claim 1 wherein the tasks include summarizing information from unstructured data sources.

5. The system of claim 1 wherein the tasks include summarizing information contained in at least a portion of a video.

6. The system of claim 5 wherein the computing system is further programmed to validate task results received from each of the task executors and identify the task results as invalid responsive to a task completion time being less than a predetermined percentage of a duration of the portion of the video.

7. The system of claim 1 wherein the computing system is further programmed to validate the task results from each of the task executors and identify the task results as invalid (i) responsive to the task results being the same for a predetermined number of responses, (ii) responsive to the task results including terms identifying components that are absent from an original source that corresponds to the task results, and (iii) responsive to the task results being unique compared to those submitted by other task executors.

8. The system of claim 1 wherein the computing system is further programmed to maintain a chain of data for the tasks that includes, for each of the tasks, data defining an original source, a relevant part of the original source, a summarization of the relevant part, and a final summary derived from the summarization for each of tasks.

9. The system of claim 8 wherein the computing system is further programmed to facilitate training of one or more machine learning models by providing the chain of data to the machine learning models as training inputs.

10. The system of claim 1 wherein the computing system is further programmed to predict accuracy of the task executors prior to distributing the templates.

11. A method for updating a knowledge base comprising:
by a computing system,
maintaining a penalty score for a task executor;
distributing a task to the task executor responsive to the penalty score being less than a predetermined threshold; and
increasing the penalty score for the task executor to a value greater than the predetermined threshold responsive to the task executor providing more than a predetermined number of responses to tasks that contain domain-specific representations that are not present in an original source associated with the tasks.

12. The method of claim 11 further comprising, increasing the penalty score for the task executor to a value greater than the predetermined threshold responsive to receiving more than a predetermined number of responses from the task executor that are the same for different tasks.

13. The method of claim 11 further comprising, increasing the penalty score for the task executor to a value greater than the predetermined threshold responsive to the task executor providing more than a predetermined number of responses that are unique compared to responses submitted by other task executors to a same task.

14. The method of claim 11 further comprising, increasing the penalty score for the task executor responsive to the task executor finishing a video-summarization task in a time that is less than a predetermined percentage of a runtime of an assigned video segment.

15. The method of claim 11 further comprising, invalidating responses that contributed to the penalty score exceeding the predetermined threshold.

16. A method for synthesizing information from unstructured data sources to update a repair knowledge base comprising:
identifying relevant parts of original sources having domain-specific knowledge related to the repair knowledge base;
creating templates including tasks for summarizing each of the relevant parts;
distributing the templates to task executors based on availability and accuracy of task executors;
aggregating solutions from the templates completed by the task executors to create a repair solution that is described as an action verb followed by a component name;
updating the repair knowledge base with domain-specific representations from the repair solution that are not presently in the repair knowledge base; and
creating and distributing new templates based on the domain-specific representations.

17. The method of claim 16 further comprising creating new machine learning model using the original sources, the relevant parts, summaries, and repair solution as training data for updating machine learning models.

18. The method of claim 16 wherein the repair solution is described as an action verb followed by a component name.

19. The method of claim 16 wherein the originals sources are documents accessed on a web-site.

20. The method of claim 16 wherein the original sources are videos accessed on a web-site.
